(19) United States
(12) Patent Application Publication
(10) Pub. No.: US 2020/0252493 A1
(43) Pub. Date: Aug. 6, 2020

(54) Universal Adapter To House Optical Accessories For Mobile Computing Devices Having Cameras

(71) Applicant: XplorStem LLC, San Diego, CA (US)

(72) Inventors: Vicki MEADOWS, San Diego, CA (US); Robert MEADOWS, San Diego, CA (US); Erika ZEHM, El Cajon, CA (US); Amanda OYAMA, San Diego, CA (US)

(73) Assignee: XplorStem LLC, San Diego, CA (US)

(21) Appl. No.: 16/779,299

(22) Filed: Jan. 31, 2020

Related U.S. Application Data
(60) Provisional application No. 62/800,354, filed on Feb. 1, 2019.

(51) Int. Cl. H04M 1/02; H04N 5/225

(52) U.S. Cl. CPC H04M 1/0264; H04N 5/2252; H04N 5/2254

(57) ABSTRACT

This invention concerns a universal adapter to hold one or more optical modification accessories (e.g., lenses, filters, etc.) for mobile computing devices having a camera. The adapter adheres to the surface of a mobile computing device above its camera. In preferred embodiments, the adapter is reusable and provides for image magnification.

### RELATED APPLICATION

This application claims the benefit of and priority to U.S. provisional patent application Ser. No. 62/800,354, filed 1 Feb. 2019 (attorney docket no. XPL-0010-PV), which has the same title as the instant application which is hereby incorporated by reference in its entirety for any and all purposes.

### BACKGROUND OF THE INVENTION

Mobile computing devices equipped with cameras are ubiquitous in today's society, and include laptop computers, tablet computers and mobile or cellular phones. The ability to utilize the camera(s) of such devices for scientific study outside of a laboratory environment has many applications, including on-site analysis of potentially dangerous specimens and in remote or underequipped locations around the world. Such devices are also useful for education in classroom and at museums and other educational facilities.

After-market image modification adapters for mobile devices exist, including those that house photographic lenses and magnifiers. These conventional adapters share similar designs where a lens is fixed in the adapter, which can be rigidly clipped or snapped onto a cell phone over its rear-facing camera, for example. Such rigidly attached adapters are not easily transferrable from device to device, resulting in limited applicability and poor image quality for less optimal fits. Cellphone geometries also change rapidly from year to year and vary from model to model and among manufacturers, even within the same manufacturer lacking standard specifications. This requires multiple and evolving adapters for existing devices.

Epoxy lenses that affix directly to a rear-facing cellphone camera (i.e., a camera that faces away from, not toward, a cell phone user) are also available commercially, but these lenses require holding the specimen at the optimal focal length for clear magnification. This limits the practical magnification range to 30-40× without use of attachments and external light sources. Furthermore, because the lens itself adheres to the phone, other lens designs and filters cannot be used, limiting its application. These lenses also require supplemental light to sufficiently visualize the subject to be photographed or examined. In some cases, the lenses are extended and have an adhesive tape to secure to the phone camera. Such lenses do not work with front-facing cell/mobile phone cameras (i.e., cameras that face toward a cell phone user). For practical and broad applications of microscopy (and other optical modification effects) across multiple devices, an easily removed and reapplied universal adapter that can house one or more lens types and/or filters for one or more of cameras of a mobile computing device is desired.

### Definitions

Before describing the instant invention in detail, several terms used in the context of the present invention will be defined. In addition to these terms, others are defined elsewhere in the specification, as necessary. Unless otherwise expressly defined herein, terms of art used in this specification will have their art-recognized meanings.

As used herein, the singular forms “a”, “an”, and “the” include plural references unless the context clearly dictates otherwise.

The term “about” refers to approximately a +/−10% variation from the stated value. It is to be understood that such a variation is always included in any given value provided herein, whether or not it is specifically referred to.

An “adapter” refers to an article or device that connects one article to another, for example, a device that allows an optical accessory to be connected to a smartphone.

A “filter” refers to an optical filter used to selectively transmit or reject a wavelength or range of wavelengths of light downstream of the filter, and is usually implemented as a glass plane or plastic device in the optical path, which are either dyed in bulk and/or have interference coatings to produce the desired frequency response.

An article is “fixed” when one or more physical structures, adhesives, or the like is/are used to secure it to or with another article. Depending on the context, fixation can be permanent or temporary.

The term “flexible” means that an article is capable of bending easily without breaking.

The term “functional association”, “functionally associate”, and the like refer to bringing two or more articles into association such that together they function as intended. For example, an optical accessory adapter of the invention is “functionally associated” with a camera system of a smartphone when the adapter is removably attached to the phone such that the adapter's optical accessory (or, if the adapter has two or more optical accessories, the accessory the user then desires to use) is positioned in relation to the camera system such that images captured by the camera system are modified by the optical accessory.

A “lens” refers to a piece of glass or other transparent substance with curved sides used to concentrate or disperse light rays.

With respect to magnification, terms such a 40×, 100×, 300×, etc. refer to 40 times, 100 times, 300 times, etc. the magnification achieved by a camera (or microscope) without the use of a magnifying device, such as a magnifying optical accessory adapter according to the invention.

An “optical accessory” is an optical device designed to work in conjunction with another, primary device. In the context of the invention, an optical accessory modifies the optics of a mobile computing device's integrated camera system, thereby resulting in a different image than would have be obtained or generated in the absence of the optical accessory. Optical accessories that provide a desired image modification, for example, filtering, distortion, magnification, etc. can be adapted for use in this invention. For example, a “filtering optical accessory” refers to an optical accessory that selectively transmits light of different wavelengths. They can be made of any suitable material(s), but often are glass or plastic. They are often dyed in bulk during manufacturing or have interference coatings. Their optical properties are described by their frequency response, which specifies how the magnitude and phase of each frequency component of an incoming signal modified by the filter. When placed in the optical path (here, the path light traverses when passing through the optical accessory of an adapter of the invention and a camera integrated into a mobile device with which the adapter is functionally associated). A “magnifying optical accessory” is one that results in some degree of magnification of the resulting image(s) generated or obtained from the camera system with which the particular magnifying optical accessory is associated by way of removably attaching the optical accessory adapter, as compared to the image that would have been generated in the absence of optical accessory.

An “optical bead” refers to a spherical bead made of optically transparent material(s). An “optical glass bead” is a spherical glass optical bead, whereas an “optical plastic bead” refers to spherical plastic bead suitable for a desired optical use. Optical beads, be they made of glass, plastics, etc., are generally made by carefully controlled manufacturing processes to produce spheres with desired diameters, surface quality, etc.

A “patentable” article, device, machine, composition, or process according to the invention means that the subject matter at issue satisfies all statutory requirements for patentability at the time the analysis is performed. For example, with regard to novelty, non-obviousness, or the like, if later investigation reveals that one or more claims encompass one or more embodiments that would negate novelty, non-obviousness, etc., the claim(s), being limited by definition to “patentable” embodiments, specifically excludes the unpatentable embodiment(s). Also, the claims appended hereto are to be interpreted both to provide the broadest reasonable scope, as well as to preserve their validity. Furthermore, if one or more of the statutory requirements for patentability are amended or if the standards change for assessing whether a particular statutory requirement for patentability is satisfied from the time this application is filed or issues as a patent to a time the validity of one or more of the appended claims is questioned, the claims are to be interpreted in a way that (1) preserves their validity and (2) provides the broadest reasonable interpretation under the circumstances.

A “plurality” means more than one.

The terms “removable”, “removably attached”, and the like means that one article, when attached to another, can be removed without damage such that the removed article can be reused if desired, including being attached (or fixed) again to the same or a different article.

### SUMMARY OF THE INVENTION

The object of the invention is to provide a universal optical accessory adapter for mobile computing devices that houses one or more optical modification accessories. Such optical accessory adapters do not require any clamp(s) or rigid permanent attachment features. Instead, they adhere to the surface of a mobile computing device proximate to the device's camera through a combination of air displacement and electrostatic forces.

Thus, in one aspect, the invention concerns an optical accessory adapter for a mobile computing device that includes at least one integrated camera. Such an adapter includes an optical accessory to modify the optical output of the camera integrated into the mobile computing device, such as a smartphone, and a flexible, reusable housing that includes an opening configured to retain and position the optical accessory in functional association with the mobile computing device's camera when the adapter is fitted thereto. In a preferred embodiment, the adapter's housing is composed of a flexible material that adheres to one or more mobile computing device exterior surfaces and is easily removable and reusable. This allows it to be attached to any mobile computing device equipped with a camera, such as the camera located on the front of mobile devices and laptops. Optical modification accessories such as optical beads and lenses are held in the device and positioned directly over the mobile computing device's camera. In some embodiments, the optical accessory adapter can be functionally associated with the front (or forward- or user-facing) camera and uses ambient light to illuminate the object to be imaged. In some embodiments, the optical accessory adapter magnifies the object being illuminated, optionally with a magnification of from about 50× to about 1000×. For example, the optical accessory adapter can be used to produce a mobile microscope for science education. In some embodiments, an optical accessory adapter of the invention may additionally, or alternatively, house a filter or other optical accessories in other openings to differently modify the optical output of a camera when the particular optical accessory is functionally associated with the camera to produce, for example, distorted or colored images for student entertainment, general education about the physics of light, etc. For example, in some embodiments an optical accessory adapter can include a magnifying accessory disposed in a first opening in the housing and a filter accessory disposed in a second opening in the housing.

A related aspect of the invention relates to methods of using an optical accessory adapter. Such methods typically involve removably attaching an optical accessory of the invention to a mobile computing device, e.g., a mobile phone, so as to functionally associate the adapter's optical accessory with a camera integrated into the mobile computing device, capturing an image with the camera, and then viewing the image. Viewing may be performed in real-time, for example, as the camera is imaging the subject(s) being viewed, or at a later time, in which event the image data generated by the camera is stored in a digital memory device associated with the mobile computing device, be it a local memory device or a remote memory device (e.g., cloud-based storage). Viewing may be on the display of the mobile computing device or it may be on a different display.

Other features and advantages of the invention will be apparent from the following drawings, detailed description, and appended claims.

### BRIEF DESCRIPTION OF THE DRAWINGS

The present invention is further detailed with respect to the following drawings, some of which may be in color. The drawings are not intended to limit the scope of the present invention but rather to illustrate certain attributes. Unless otherwise indicated, it is understood that the drawings are not to scale, as they are intended merely to facilitate understanding of the invention as opposed to specific dimensions, etc. In the drawings, like numbers in two or more drawings represent the same elements. The patent or application file contains at least one drawing executed in color. Copies of this patent or patent application publication with color drawing(s) will be provided by the Office upon request and payment of the necessary fee.

FIG. 1 and FIG. 2 are front and side views of a representative embodiment of the invention. In the embodiment depicted, the universal optical accessory adapter has one opening to accommodate an optical accessory (or “modification”) device. In other embodiments of the invention, one or more additional openings can be included to accommodate multiple optical accessory devices. Features may also be included in an optical accessory adapter to accommodate other functions of the mobile computing device to which the adapter is removably attached, such as an aperture for alignment with a rangefinder, proximity sensing, audio output, etc. of a mobile phone.

FIG. 3 illustrates an optical accessory adapter of the invention removably attached to a cellphone, with the opening of the adapter aligning its included optical accessory (e.g., a magnifying glass bead, filter, etc.) with the forward-facing camera of a mobile phone.

FIG. 4 depicts a representative embodiment of the invention where the optical accessory adapter is attached to the front of a cell-phone such that the optical accessory is aligned with the cell phone camera, particularly with the camera's optical path such that light incident with the camera's image sensor(s) first passes through such optical accessory. Lighting is often provided by ambient sources such as natural or artificial indoor illumination, although in some embodiments additional lighting may be provided, if desired. In some embodiments, the optical accessory magnifies a sample aligned with the adapter and cellphone camera. The magnified sample may be viewed using the mobile computing device's screen and, if desired, a digital image can be captured by standard methods. In others embodiments, the adapter of the invention may house a filter or different bead or lens for the purpose of modifying images captured by the mobile device's camera.

### DETAILED DESCRIPTION OF THE INVENTION

The present invention is a universal optical accessory adapter that houses one or a series of different optical modification accessories for use with one or more of the cameras built into a mobile computing device, e.g., a smartphone, a tablet computer, a laptop computer, etc. In some embodiments, an adapter of the invention is used with a camera on the front of the mobile device. The adapters of the invention removably adhere to a mobile computing device so as to position an optical modification accessory over a camera of the mobile computing device.

An adapter of the invention is removably attached to a mobile device through any suitable releasable adhesive technology, allowing the adapter to removable and reusable (with the same or different smartphone, for example). In general, an adapter removably adheres to a mobile computing by forming a tight seal after all air is removed. Preferably, the adapter is held in place through a combination of suction and non-specific electrostatic forces. A representative example of such adherence technology is the attachment of flexible decals to windows. In comparable embodiments of the invention, the adapter is produced from pre-manufactured flexible materials that are modified to specifications or 3D-printed using flexible filaments. In a particularly preferred embodiment, the adapter is 3D-printed using opaque, snow colored NinjaFlex 1.75 mm 0.5 kg filament. In other preferred embodiments, translucent filament can be used for an unusual effect that includes optical modification of the sample overlaid with an unmodified image of the surroundings viewed peripherally through the translucent apparatus. In other embodiments, filaments of different colors and levels of transparency may be used to produce effects for aesthetics, entertainment, optics education, or art.

An adapter houses one or more optical modification accessories. Such devices include but are not limited to lenses, beads, and/or filters. Such optical accessories can be pre-manufactured or prepared to specifications and may be of different sizes. If desired, optical modification accessories of different sizes can be accommodated during manufacture by changing the size of the corresponding accommodating hole (or port or other opening) in the adapter and the size of the adapter. In certain preferred embodiments, the adapter is 1.5 mm thick and printed with a 1.25 mm hole, which have been found to be optimal print parameters when using a DaVinci Pro xyz 3D printer to produce a flexible housing for a 1 mm glass bead. As will be appreciated, the hole(s) housing to accommodate optical accessories can be introduced using any suitable method, including but not limited to during a 3D printing process, or through post-processing using, for example, drills, stamps, and/or lasers. In the currently preferred embodiments, adapters are 3D-printed with holes designed to accommodate the desired optical accessory(ies). In these embodiments, upon removal of an adapter from the printer stage, the hole shrinks to the optimal size to securely fix the glass bead. The bead is introduced in advance of removing the adapter from the printer, allowing the housing to shrink around the glass bead as the polymer cures, thereby sealing or fixing the glass bead within the housing and thus eliminating the need for an additional polymer adhesive or mechanical structure to secure the glass bead within the opening in the housing. Of course, in some embodiments, adhesives can be used to retain the optical accessory within the housing.

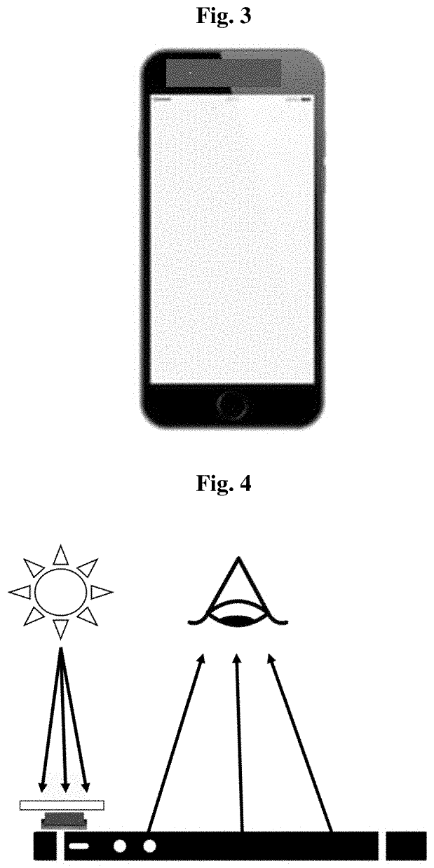

In the embodiment described above, a 1 mm glass bead is inserted into the optical accessory adapter for the purpose of magnification. The adapter, when functionally associated with, for example, a smartphone (see, e.g., FIG. 3), becomes removably attached to the smartphone through the inherent adhesive properties of the adapter's housing, with the optical accessory (here, a magnifying glass bead) positioned in the optical path of one of the smartphone's cameras (in FIG. 3, the mobile phone's front-facing camera). Glass beads of the sort used in this representative embodiment can be purchased commercially or custom made to particular specifications. To manufacture such a magnifying optical adapter, commercially purchased 1 mm glass beads were individually isolated and manually inserted into each housing during the 3D printing process. As will be appreciated, such glass beads may vary in quality, but all beads meeting the desired specifications are generally sufficient to achieve the intended magnification due to their curvature. The degree of magnification provided by a particular bead largely depends on its size/curvature. For a 1 mm glass beads, images captured by the smartphone's front-facing camera (see FIG. 3) were magnified up to 350×, which is sufficient to visualize organisms at the cellular level. Images so captured can be viewed on any suitable display, including on the smartphone's touchscreen display, in real time or subsequently (provided that images were stored in a memory functionally associated with the mobile device). In a preferred embodiment such as described herein, the focal length of the camera lens/glass bead system allows examination of samples by placing them directly over the opening in the housing in which the optical accessory (here, a 1 mm glass bead; see FIG. 4) is fixed. Ambient overhead light can be used to visualize the sample. This light may be natural sunlight, artificial overhead lighting, or be supplied by portable lighting devices.

In other embodiments, an optical accessory adapter of the invention can be manufactured to house commercially available beads of different sizes and/or compositions, custom-prepared beads, and lenses manufactured from optically clear resin or glass in order to produce different levels of magnification.

Beyond magnification, adapters of the invention can also be prepared to house lenses, beads, or filters designed to distort or otherwise modify the optical characteristics of a camera of a mobile device to which a user fixes the adapter in order to alter the image output by the camera. For example, the optical accessory fixed in the adapter's housing can be cut glass, which can produce a kaleidoscopic view of a sample imaged by a camera system including such an adapter. In another example, a filter can be used to change the color of images taken of a desired sample by a user using the camera of a mobile computing device to which an adapter of the invention is removably attached. As those in the art will appreciate, such embodiments include but are not limited to cases that mimic the vision of other species, which can be used, for example, as teaching tools, for professional photography, for artistic reasons, or for fun.

In a preferred example of an optical accessory adapter used to temporarily convert a smartphone into a portable microscope (as might be used, for example, in a science exercise for K-12 students), students can go on adventures where they explore the microscopic world around them. They could, for example, examine samples in their pantry, backyard, at school, or even in local museums. In some embodiments of this sort, a mobile microscope in accordance with the invention could be interface with a mobile application that provides direction for such adventures and allows players/participants to capture and upload images to be stored in and accessed from an online database. As should be apparent, such a mobile microscope could also be used by schools to facilitate examination of samples both in the classroom or on school-organized field trips.

A mobile microscope of the invention may also be used to capture images of samples outside of a laboratory to be examined by professional scientists. In an example, a crime scene investigator or first responder can capture images of evidence or a suspicious sample that can be provided electronically to scientists on call in real time. Similarly, scientists can capture images of samples available only outside the laboratory for examination and documentation of events or scientific studies.

The mobile microscope application of this invention also addresses issues with existing mobile phone microscope attachments, which generally depend on the geometry of the cellular phone to which such accessories are attached. In cases where the attachment is a clamp housing a magnification lens, the ability to use the attachment depends on the thickness of the phone and the phone case. Optimal fit is required for clear magnification, so even if the magnifying accessory can be attached, the image is often sub-optimal or unusable. In other cases, the attachment slides onto the phone, resulting in even more limited applicability.

As those in the art will appreciate, this invention does not require rigid attachment to a mobile phone (or other mobile computing device). Instead, the invention adheres directly to the mobile device. In preferred embodiments, the adapter adheres through surface forces resulting from displacement of air between the adapter and computing device. The adapter may therefore be attached to any smooth surface, including but not limited to those of cell-phones, tablets, and laptops, provided that the optical accessory housed therein is aligned with a camera integrated into the mobile device. The adapter may be equipped with one or more holes each housing a different optical accessory, in which event a user can at any time choose which optical accessory to align with the mobile device's camera. If a different optical accessory is desired, the user can simply reposition the adapter to functionally associate the then-desired optical accessory with the mobile device's camera.

The mobile microscope embodiments of the invention also address issues with lenses constructed from epoxy materials that attach directly to the back camera (i.e., rear-facing, or facing away from the a smartphone's touchscreen display). Such epoxy-based lenses require that a user hold the camera at an optimal focal length. As magnification increases, the depth of field decreases such that the practically achieved magnification with such lenses is ˜40×, significantly less than the mobile microscope embodiment described above that provides for magnification of about 350×. Higher magnification may be achieved with the pre-manufactured lenses, but such conventional devices require a separate attachment to hold the cellphone steady at the optimum focal length. The design of the instant invention, particularly preferred embodiments utilizing a front-facing cellphone camera, results in the optimum focal length being provided by placing the specimen for examination on top of the adapter.

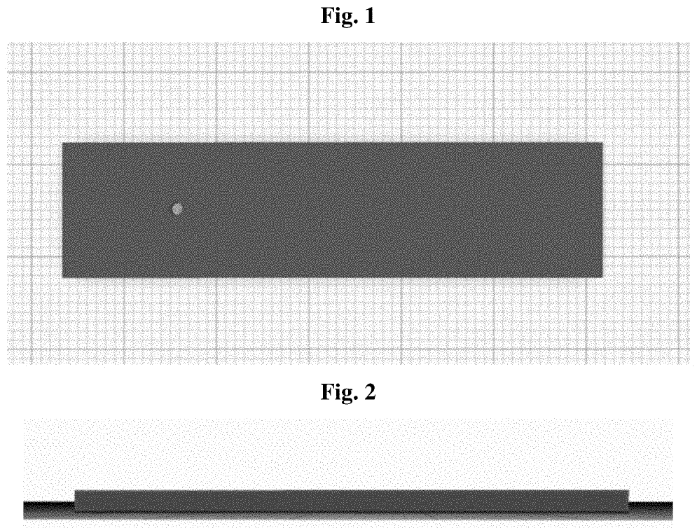

FIGS. 1-4 summarize certain preferred magnifying embodiments of the invention. FIGS. 1 and 2 illustrate top and side views of on such preferred embodiment, which houses a single optical modification device utilizing a 1 mm glass bead for the purpose of magnification. This embodiment was produced using a 3D printer equipped with NinjaFlex filament. Preferred embodiments use flexible filament but are not limited to NinjaFlex. The embodiment in the Figures is printed with a 1.5 mm hole and is 1.25 mm thick, which after removal from the printer bed, shrinks in size and securely holds the 1 mm glass bead and can be temporarily adhered, removed, and re-applied to the front of a cellular phone, tablet, or laptop. FIG. 3 depicts the embodiment from FIG. 1 attached to the front of a cellular phone, placing the optical accessory of the adapter over the front-facing cell-phone camera. Because the method of attachment is based upon the physical properties of the adapter and the front-facing surface of the smartphone, these preferred adapter embodiments could be applied to any smooth surface. In other embodiments, the adapter is attached to the front of a tablet or laptop. The adapter may also be attached to any brand of cellphone and is independent of cellphone geometry. FIG. 4 depicts a method of using a universal adapter as shown in FIG. 3. In this embodiment, the adapter is used to view a sample directly placed over the magnifying optical accessory housed in the adapter, which magnifying optical accessory is held in place over the front cellphone camera by the universal adapter. The sample is illuminated by overhead light. In this embodiment, light is provided by the sun. The user may directly view the resultant magnified image of the sample on cellphone display. In the embodiment in FIGS. 1 and 2, the 1 mm glass bean results in an image with 350× magnification of the sample. This magnification is enough to view samples at the cellular level.

Unless the context clearly requires otherwise, throughout the description above and the appended claims, the words “comprise,” “comprising,” and the like are to be construed in an inclusive sense as opposed to an exclusive or exhaustive sense; that is to say, in a sense of “including, but not limited to.”

Words using the singular or plural number also include the plural or singular number, respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list, and any combination of the items in the list.

The foregoing description, for purpose of explanation, has been described with reference to specific embodiments. However, the illustrative discussions above are not intended to be exhaustive or to limit the invention to the precise forms disclosed. Many modifications and variations are possible in view of the above descriptions. The embodiments were chosen and described in order to best explain the principles of the invention and its practical applications to thereby enable others skilled in the art to best utilize the invention and various embodiments with various modifications as are suited to the particular use contemplated. As such, the invention extends to all functionally equivalent structures, methods, and uses, such as are within the scope of the appended claims, and it is intended that the invention be limited only to the extent required by the applicable rules of law.

1. An optical accessory adapter, comprising:
a. an optical accessory to modify the optical output of a camera integrated into a mobile computing device, optionally a mobile phone; and
b. a flexible, reusable housing comprising an opening configured to retain and position the optical accessory in functional association with the mobile computing device camera when the adapter is fitted to the mobile computing device, wherein the housing is adapted for removable and repeated attachment to a surface of a mobile computing device proximate to the mobile computing device's camera.

2. An optical accessory adapter according to claim 1 wherein optical accessory magnifies images captured by the camera, optionally with a magnification of from about 50× to about 1000×.

3. An optical accessory adapter according to claim 2 wherein the optical accessory is a lens or a series of lens.

4. An optical accessory adapter according to claim 3 wherein the lens is an optical bead, optionally an optical glass bead.

5. An optical accessory adapter according to claim 1 comprising a plurality of optical accessories each retained in a different opening in the housing and each adapted to differently modify the optical output of a camera when the particular optical accessory is functionally associated with the camera.

6. An optical accessory adapter according to claim 5 that comprises a magnifying accessory disposed in a first opening in the housing and a filter accessory disposed in a second opening.

7. An optical accessory adapter according to claim 1 wherein the optical accessory is fixed in the corresponding opening of the housing.

8. An imaging system, comprising an optical accessory adapter according to claim 1 functionally associated with a camera of a mobile computing device.

9. A mobile microscope, comprising an optical accessory adapter according to claim 1 functionally associated with a camera of a mobile computing device, optionally a smartphone, wherein the optical accessory of the optical accessory adapter provides magnification of images captured by the camera.

10. A method of using an optical accessory adapter, comprising:
a. removably attaching an optical accessory adapter according to claim 1 to a mobile computing device, optionally a mobile phone, so as to functionally associate the adapter's optical accessory with the camera; then
b. capturing an image with the camera; and then
c. viewing the image.
